(19) United States
(12) Patent Application Publication
(10) Pub. No.: US 2012/0235442 A1
(43) Pub. Date: Sep. 20, 2012

(54) REINFORCED STRUCTURAL ASSEMBLY WITH ACOUSTIC FOAM MEMBER AND METHOD OF REINFORCING VEHICLE COMPONENTS

(75) Inventors: Hesham A. Ezzat, Troy, MI (US); Pei-Chung Wang, Shanghai (CN); Marcel R. Cannon, Romeo, MI (US); Kangping Wang, Troy, MI (US)

(73) Assignee: GM GLOBAL TECHNOLOGY OPERATIONS LLC, Detroit, MI (US)

(21) Appl. No.: 13/048,994

(22) Filed: Mar. 16, 2011

(51) Int. Cl. B62D 29/00; B21D 53/88

(52) U.S. Cl. 296/187.02; 29/897.2

(57) ABSTRACT

A reinforced structural assembly includes a first vehicle component and a second vehicle component attached to the first vehicle component to define a substantially closed cavity. An acoustic foam member is contained within a container, also referred to as a vehicle pouch, containing the acoustic foam member and is made of a material that has a predetermined strength. A sealant with adhesive properties is included on at least a portion of an outer surface of the container, and is impregnated within or coated onto the container. The container and the acoustic foam member substantially fill the cavity so that the outer surface of the container contacts at least a portion of an inner surface of the vehicle components and the sealer seals the acoustic foam member and adheres the container to the inner surface of the attached vehicle components. A method of reinforcing vehicle components is provided.

### TECHNICAL FIELD

The invention relates to a reinforced structural assembly for a vehicle and a method of reinforcing vehicle components.

### BACKGROUND

Vehicles often have frames, pillars, rockers, and other structural members that are an assembly of different thin wall members. For example, a B-pillar typically has a B-pillar outer member and a B-pillar inner member, both of which are a relatively thin steel, an aluminum alloy, or a ferrous, non-ferrous or polymer material. The inner and outer member are welded or otherwise joined together, and define a cavity between them. At a cross section generally perpendicular to the length of the pillar members, the members define a cavity. Typically, the members are reinforced to meet predetermined strength, stiffness, and load-bearing requirements by attaching additional steel or aluminum alloy brackets within the cavity. The brackets must be preformed to the interior dimensions of the cavity prior to installation in the cavity.

At other locations, or at the same locations within the cavity as the reinforcing brackets, noise reduction may be desired. Foam baffles are often used for noise reduction. The baffles are preformed to match the interior shape of the cavity prior to insertion into the cavity.

### SUMMARY

A reinforced structural assembly for a vehicle is provided, as well as a method of reinforcing vehicle components. The assembly serves both structural reinforcement and noise reduction functions heretofore addressed by separate brackets and foam baffles, reducing both the number of components and mass of the the vehicle components.

The reinforced structural assembly includes a first vehicle component and a second vehicle component attached to the first vehicle component to define a substantially closed cavity therebetween. An acoustic foam member is contained within a container, also referred to as a vehicle pouch, that is made of a material that has either a predetermined strength or a predetermined load-bearing capability, or both. A sealant with adhesive properties is included on at least a portion of an outer surface of the container, and is either impregnated within the container or coated onto the container. The container and the acoustic foam member substantially fill the cavity so that the outer surface of the container contacts at least a portion of an inner surface of the vehicle components. The sealer seals the acoustic foam member and adheres the container to the at least a portion of the inner surface of the attached vehicle components. Appropriate structural reinforcement is achieved locally within the joined members by the container, and the foam member provides desired acoustic isolation characteristics.

A method of manufacturing a structural assembly for a vehicle includes securing a flexible container at least partially filled with expandable foam to a first vehicle component. A second vehicle component is then joined to the first vehicle component such that the flexible container at least partially filled with expandable foam is within a cavity defined by the first and the second vehicle components. The foam is then expanded such that the foam and the flexible container substantially fill the cavity and the flexible container contacts at least a portion of an inner surface of the joined vehicle components.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional illustration of a container being filled with expandable acoustic foam;

FIG. 2 is a schematic perspective illustration in partial fragmentary view of the filled container of FIG. 1 placed in a first vehicle component;

FIG. 3 is a schematic cross-sectional illustration of the filled container and first vehicle component of FIG. 2, taken at the lines 3-3 in FIG. 2, with a second vehicle component being placed thereon;

FIG. 4 is a schematic cross-sectional illustration of the filled container and vehicle components of FIG. 3 with the vehicle components welded to one another;

FIG. 5 is a schematic cross-sectional illustration of the filled container and vehicle components of FIG. 4 in an oven with the foam expanding;

FIG. 6 is a schematic cross-sectional illustration of the filled container sealing the expanded foam and adhered to the attached vehicle components; and

FIG. 7 is a flow diagram of a method of reinforcing vehicle components, such as the vehicle components of FIGS. 2-6.

### DETAILED DESCRIPTION

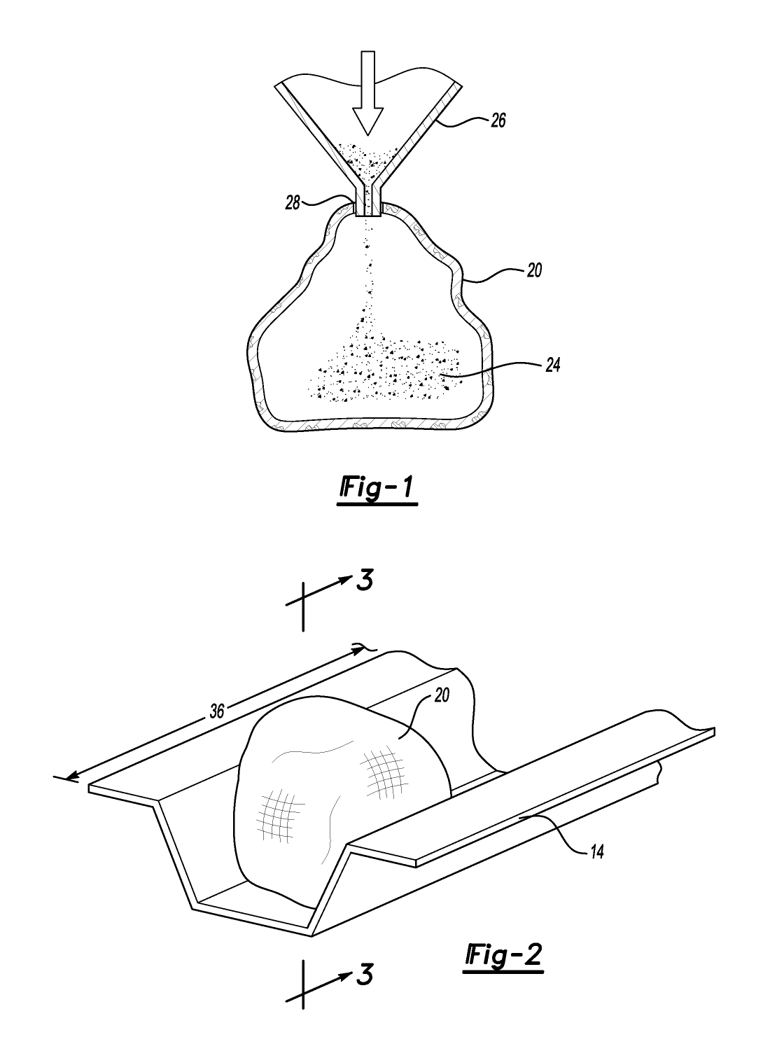

Referring to the drawings, wherein like reference numbers refer to like components throughout the several views, FIGS. 1 to 6 show various stages of manufacture of a reinforced structural assembly 10 for a vehicle 12, with the structural assembly 10 completed in FIG. 6. The reinforced structural assembly 10 is relatively lightweight and strong in comparison to structural assemblies reinforced according to known methods, and is configured to act as an acoustical barrier. Specifically, referring to FIG. 6, the reinforced structural assembly 10 includes a first vehicle component 14 attached to a second vehicle component 16. The vehicle components 14, 16 may be any components of the vehicle 12 that define a closed cross-section when attached, with a cavity being enclosed by the components 14, 16 at the closed cross-section. As used herein, a “closed cross-section” means that, at a cross-section through the components 14, 16, the components 14, 16 define a periphery that completely surrounds and encloses a cavity. Many thin-walled vehicle components define closed cross-sections. For example, the vehicle components 14, 16 may be vehicle frame members, vehicle rocker members, vehicle pillar members, or vehicle roof rails, or any other components assembled to one another to form a closed cross-section.

The vehicle components 14, 16 are reinforced with an acoustic foam member 18 in a reinforcing container 20, also referred to as a pouch, that substantially fills a cavity 22 defined between the attached vehicle components 14, 16. Unlike typical reinforcing members, such as steel brackets, the acoustic foam member 18 and reinforcing container 20 need not be preformed to the internal geometry of the cavity 22. This allows the manufacture of the reinforced structural assembly 10 to be simpler and less expensive, with fewer assembly steps.

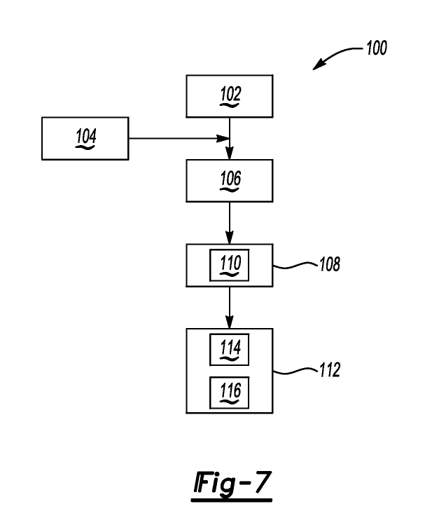

A method of manufacturing the reinforced structural assembly 10 of FIG. 6 is illustrated as a flow diagram in FIG. 7. The method 100 is described with respect to FIGS. 1-6. Specifically, referring to FIGS. 1 and 7, the method 100 begins with block 102, filling the flexible container 20 at least partially with a premeasured quantity of an expandable foam 24. In FIG. 1, the expandable foam 24 is filled from a dispenser 26, which may be an automated robotic assembly, through an opening 28 in the container 20. When the container 20 is filled to a predetermined level with the expandable foam 24, the opening 28 is sewed or otherwise closed.

The flexible container 20 may be a variety of reinforcing materials, such as a carbon fiber fabric, a steel mesh or a para-arimid fabric, such as KEVLAR, which is a registered trademark of E. I. du Pont de Nemours and Company and is available from DuPont Advanced Fibers Systems, Richmond, Va. The material of the flexible container 20 is selected to have at least a predetermined strength in order to serve as a strengthening member within the assembled components 14, 16. The fabric or mesh construction of the flexible container 20 allows it to be either impregnated with or coated with a sealant 30, shown in FIG. 3, that also has adhesive properties. In case of the latter, the method 100 includes optional block 104, coating at least a portion of an outer surface 32 of the container 20 with sealant 30. The sealant 30 is preferably flexible.

The expandable foam 24 is an acoustic foam that expands upon heating under predetermined conditions, or expands in response to a different catalyst. As used herein, “acoustic foam” is a foam used to dissipate sound by attenuating sound waves at least by a predetermined amount.

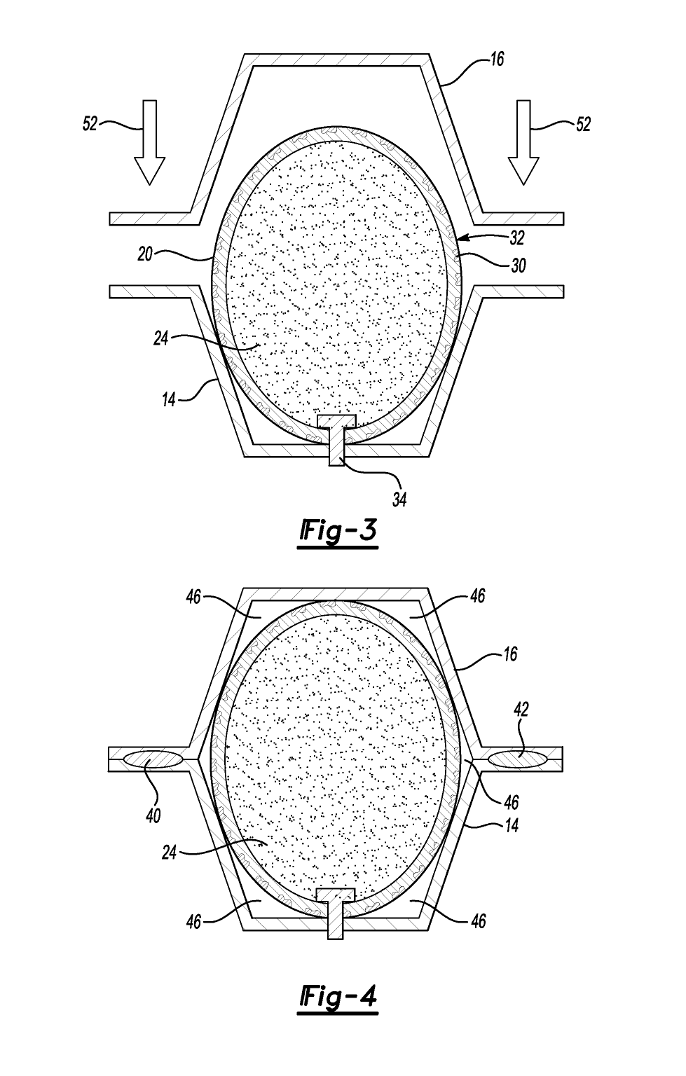

Referring to FIGS. 3 and 7, the method 100 then includes block 106, securing the flexible container 20 at least partially filled with the expandable foam 24 to the first vehicle component 14. As shown in FIG. 3, the container 20 may be secured to the first vehicle component by a fastener 34 that extends through the pouch and fits to the first vehicle component 14. The fastener 34 may be threaded to a threaded opening on the first vehicle component 14, or otherwise secured thereto. The container 20 is secured at a predetermined location on the first vehicle component 14 at which it has been determined that reinforcement and noise reduction is beneficial on the vehicle 12. As shown in FIG. 2, the container 20 need not extend the entire straight and/or curved length 36 of the first vehicle component 14.

Referring to FIG. 3, after the container 20 is secured to the first vehicle component 14, the second vehicle component 16 is placed adjacent the first vehicle component 14, as indicated by arrows 52. In block 108 of FIG. 7, the second vehicle component 16 of FIG. 4 is joined with the first vehicle component 14 so that they are rigidly connected to one another. The joining of block 108 of FIG. 7 may be carried out by welding in block 110, as indicated by welds 40 and 42 of FIG. 4. The welds 40, 42 are spot welds. Other types of welding, or other ways of joining the first and second vehicle components 14, 16, such as by structural adhesives, may be used instead of or in addition to the welding.

The volume of container 20 with expandable foam 24 (in its pre-expansion form of FIG. 2) is less than the volume of cavity 22, as represented by the area of the expandable foam 24 and container 20 at the cross section and evidenced by voids 46 at the cross-section.

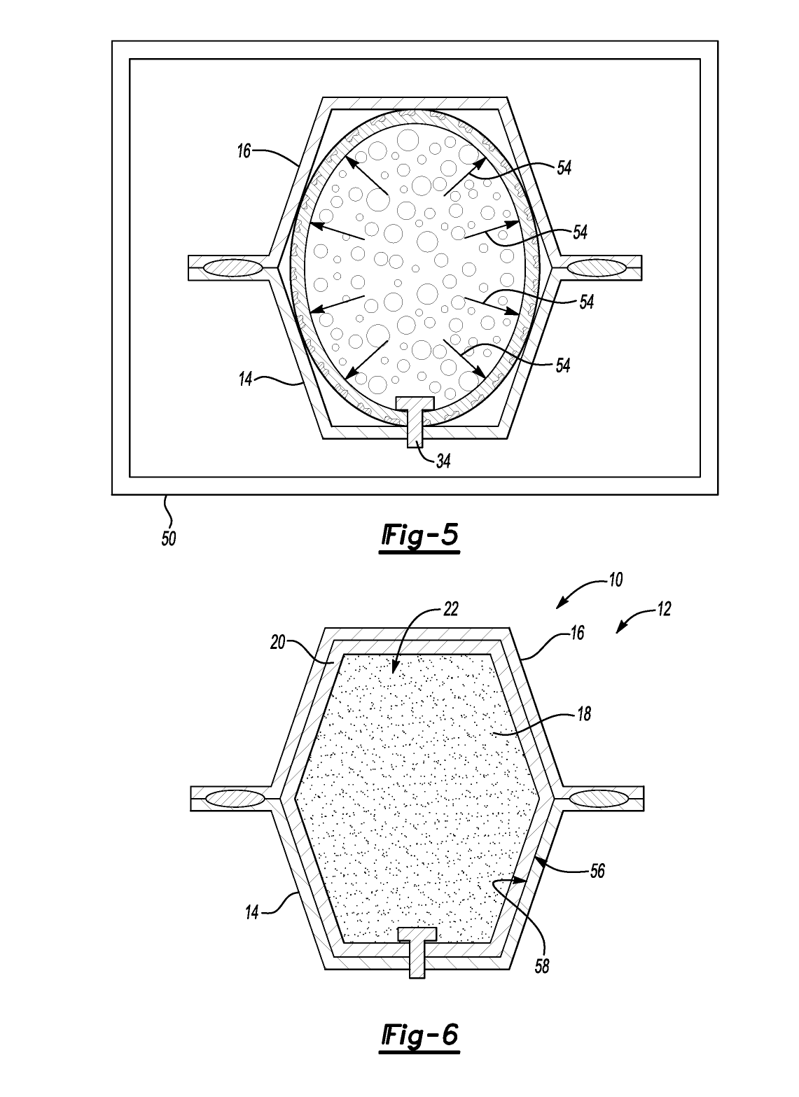

Once the first and second components 14, 16 are joined in block 108, the acoustic foam 24 is expanded in block 112 of FIG. 7. Block 112 may include block 114, placing the assembled first and second components 14, 16 with the container 20 and the acoustic foam 24, in an oven 50 of FIG. 5, and heating the oven 50 in block 116 of FIG. 7. The oven 50 may be an electro-coat paint operation (“ELPO”) oven or similar high throughput oven. Any other known means of expanding the foam 24 may be employed in block 112. As shown in FIG. 5, the foam 24 expands outward in all directions indicated by arrows 54, forcing the container 20 against the vehicle components 14, 16. Foam that has expanded cools to form acoustic foam member 18 of FIG. 6 that, along with the container 20, conforms to the geometry of the joined first and second components 14, 16. In other words, the acoustic foam member 24 and container 20 fill the cavity 22 at the cross-section so that an outer surface 56 of the container 20 contacts and is adhered to an inner surface 58 of the joined vehicle components 14, 16. The cross-sectional area of the acoustic foam member 24 and container 20 is substantially equal to the cross-sectional area of the cavity 22 at the cross section shown in FIG. 6. The container 20 with sealant 30 (shown in FIG. 3) helps to seal the acoustic foam member 18 from moisture. Additionally, the material chosen for the container 20 at a predetermined strength, along with the foam member 18 act as a structural reinforcement of the first and second vehicle components 14, 16. The acoustic foam member 18 acts to reduce noise. The reinforcement function and noise reduction function are accomplished with relatively few processing steps, and with relatively little added weight.

While the best modes for carrying out the invention have been described in detail, those familiar with the art to which this invention relates will recognize various alternative designs and embodiments for practicing the invention within the scope of the appended claims.

1. (canceled)

2. (cancelled)

3. (cancelled)

4. (cancelled)

5. (cancelled)

6. A method of manufacturing a structural assembly for a vehicle comprising:
securing a flexible container at least partially filled with expandable foam to a first vehicle component;
joining a second vehicle component to the first vehicle component such that the flexible container at least partially filled with expandable foam is within a cavity defined by the first and the second vehicle components; and
causing the foam to expand such that the foam and the flexible container substantially fill the cavity and the flexible container contacts at least a portion of an inner surface of the joined vehicle components.

7. The method of claim 6, further comprising:
filling the flexible container with the expandable foam prior to securing the flexible container to the first vehicle component.

8. The method of claim 6, wherein the cavity is larger than the flexible container at least partially filled with expandable foam at a cross-section of the assembly prior to expansion of the foam, and wherein the cavity is substantially filled by the container and the expanded foam at the cross-section of the assembly after expansion of the foam.

9. The method of claim 6, wherein said joining the second component to the first component is by welding.

10. The method of claim 6, wherein said causing the foam to expand is by heating.

11. The method of claim 10, further comprising:
prior to said heating, placing the joined vehicle components with the flexible container at least partially filled with expandable foam secured thereto in an oven.

12. The method of claim 6, further comprising:
coating at least a portion of an outer surface of the container with sealant prior to securing the flexible container at least partially filled with expandable foam to the first vehicle component.

13. A method of manufacturing a structural assembly for a vehicle comprising:
filling a flexible container at least partially with an expandable foam; wherein an outer surface of the flexible container has a sealant with adhesive properties;
securing the flexible container at least partially filled with the expandable foam to a first vehicle component;
welding a second vehicle component to a flange of the first vehicle component adjacent the flexible container such that the flexible container at least partially filled with the expandable foam is within a closed cavity defined by the welded first and the second vehicle components; and
causing the foam to expand such that the foam and the flexible container substantially fill the cavity, the flexible container contacts at least a portion of an inner surface of the joined vehicle components, and the sealant with adhesive properties adheres the flexible container to said at least a portion of the inner surface of the joined vehicle components and seals the expanded foam.

14. The method of claim 6, wherein said securing includes threading a fastener to the first vehicle component.

15. The method of claim 6, further comprising:
impregnating the container with sealant.

16. The method of claim 7, wherein said filling is through an opening in the flexible container, and further comprising:
sewing shut the opening of the flexible container prior to said securing the flexible container to the first vehicle component.

17. The method of claim 7, wherein said filling includes measuring a predetermined quantity of said expandable foam prior to said filling.

18. The method of claim 13, wherein said securing includes threading a fastener to the first vehicle component.

19. The method of claim 13, wherein said filling is through an opening in the flexible container, and further comprising:
sewing shut the opening of the flexible container prior to said securing the flexible container to the first vehicle component.

20. The method of claim 13, further comprising:
impregnating the container with the sealant.

21. The method of claim 13, wherein said filling includes measuring a quantity of said expandable foam prior to said filling.

22. A method of manufacturing a structural assembly for a vehicle comprising:
measuring a predetermined quantity of expandable foam;
filling a flexible container at least partially with the predetermined quantity of expandable foam; wherein an outer surface of the flexible container has a sealant with adhesive properties; wherein said filling is through an opening in the flexible container;
sewing shut the opening of the flexible container;
after said sewing shut, securing the flexible container at least partially filled with the expandable foam to a first vehicle component; wherein said securing includes threading a fastener to the first vehicle component;
welding a second vehicle component to a flange of the first vehicle component adjacent the flexible container such that the flexible container at least partially filled with the expandable foam is within a closed cavity defined by the welded first and second vehicle components; and
causing the foam to expand such that the foam and the flexible container substantially fill the cavity, the flexible container contacts at least a portion of an inner surface of the joined vehicle components, and the sealant with adhesive properties adheres the flexible container to said at least a portion of the inner surface of the joined vehicle components and seals the expanded foam.
